(19) United States
(12) Patent Application Publication
(10) Pub. No.: US 2023/0024007 A1
(43) Pub. Date: Jan. 26, 2023

(54) A NON-INVASIVE LOAD DECOMPOSITION METHOD

(71) Applicant: Guizhou Power Grid Company Limited, Guiyang (CN)

(72) Inventors: Zhukui TAN, Guiyang (CN); Bin LIU, Guiyang (CN); Qiuyan ZHANG, Guiyang (CN); Chenghui LIN, Guiyang (CN); Jipu GAO, Guiyang (CN); Dunhui CHEN, Guiyang (CN); Houpeng HU, Guiyang (CN); Qiji DAI, Guiyang (CN); Chao DING, Guiyang (CN); Saiqiu TANG, Guiyang (CN)

(21) Appl. No.: 17/787,335

(22) PCT Filed: Dec. 31, 2020
(86) PCT No.: PCT/CN2020/141886

§ 371 Date: Jun. 20, 2022

(30) Foreign Application Priority Data
Apr. 17, 2020 (CN) 202010302679.5

(51) Int. Cl. G06K 9/62

(52) U.S. Cl. CPC G06K 9/6297; G06K 9/6298

(57) ABSTRACT

The invention discloses a non-invasive load decomposition method, which includes: step 1, obtaining the power fingerprint information of each load; step 2, clustering the operating state of loads through the clustering algorithm, calculate statistical values of each cluster, and encoding the operating state of electrical appliances; step 3, establishing a hidden Markov model with multiple-parameters and calculating the model parameters; step 4, performing state recognition based on Viterbi algorithm and obtaining predicted state sequence; step 5, according to the predicted state sequence and the statistical values of each cluster, decomposing the load power based on the maximum likelihood estimation principle; step 6, outputting the state sequence and power decomposition results. The invention solves the conventional load identification algorithm problems, such as complex model, insufficient use of electrical features and low accuracy of unknown information.

### FIELD OF THE INVENTION

The invention belongs to a load decomposition technology, in particular to a non-invasive load decomposition method based on power fingerprint and a hidden Markov model with multiple parameters.

### BACKGROUND OF THE INVENTION

At present, the concept of smart grid is in the ascendant, and more and more scholars and power grid companies participate in the theoretical research and practical exploration of smart grid. Advanced Metering Infrastructure (AMI) is a key part of smart grid construction. As one of the most important components of AMI, load monitoring and identification is the first step to realize smart power grid. Based on load monitoring and identification technology, power grid companies can understand the state and energy consumption of loads, and then use big data and other technical means to describe the load's energy consumption pattern and user's power consumption behavior, so as to realize demand response, optimize the allocation of power resources and support the construction of smart grid. With the establishment of advanced measurement system, non-invasive load detection and identification began to be proposed. Non-invasive load monitoring (NILM) is one of the key technologies of demand side management in the future because of its high acceptance by users and low equipment input cost compared with the commonly used invasive load decomposition technology.

However, non-invasive load decomposition technology is not mature, existing technology has proposed a variety of load identification algorithms. The improved or expanded HMM model can greatly improve the accuracy of non-invasive load identification, but there are some problems such as complicated model, insufficient use of electrical characteristics and insufficient consideration of unknown information.

### SUMMARY OF THE INVENTION

The technical problem to be solved by the invention: for solving the technical problems of load identification algorithm of conventional art using improved or expanded HMM model, which improves the accuracy of non-invasive load identification, such as complicated model, insufficient use of electrical characteristics and insufficient consideration of unknown information, a non-invasive load decomposition method is provided.

The technical scheme of the invention is as follows:

A non-invasive load decomposition method, comprising:

Step 1, obtaining power fingerprint of each electrical appliance to generate training data and test data;

Step 2, clustering working states of electrical appliances through a clustering algorithm, calculating average values and standard deviation of each cluster, and encoding the working states of electrical appliances;

Step 3, establishing a hidden Markov model with multiple parameters and calculating model parameters;

Step 4, importing the test data and performing clustering;

Step 5, performing state recognition based on Viterbi algorithm and obtaining a predicted state sequence;

Step 6, according to the predicted state sequence and statistical values of each cluster, decomposing a load power based on maximum likelihood estimation principle; and

Step 7, outputting state sequence and power decomposition result.

Method of the step 1's obtaining the power fingerprint of each electrical appliance to generate the training data and the test data comprises: obtaining the power fingerprint of each electrical appliance; selecting active power and steady-state current data of each sampling point of each electrical appliance from the data set; dividing the selected active powers and steady-state current data into groups according to time as the training data and the test data, wherein the power fingerprint of each electrical appliance includes the active power and the history data of 1^{st} to 11^{th} harmonics of steady-state operating current of each electrical appliance.

Method of the step 2's clustering the working states of the electrical appliances through the clustering algorithm, calculating the average values and the standard deviation of each cluster, and encoding the working states of the electrical appliances comprises: clustering the working states of electrical appliances by using k-means clustering algorithm, and calculating the average values and standard of each cluster after the clustering results were obtained; and performing state coding to each electrical appliance, so as to encode working state vector of each electrical appliance into a binary state.

Method of performing the state coding to each electrical appliance, so as to encode the working state vector of each electrical appliance into the binary state comprises:

Step 2.1, allocating bits, comprising: determine binary bits required for encoding according to the number of states of electrical appliances;

Step 2.2, determining values, comprising: calculating binary state values according to decimal state values of the electrical appliances at current moment; and

Step 2.3, splicing representation, comprising: splicing, according to the order of electrical appliances, the binary state values from high to low to get a final result.

Method of the step 3's establishing a hidden Markov model with multiple parameters and calculating model parameters comprises:

Step 3.1, using S to represent a set of combined operating states of each electrical appliance, and that S is a set of total states, wherein the set a complete sorting of the operating states of each electrical appliance, and the number of elements in the set is determined by the number of clusters of the states of each electrical appliance;

Step 3.2, using V to represent total power fingerprint set of total user power consumption, elements of set V , represented as vᵢ=[Pᵢ^{L}, Iᵢ^{L}], include vectors constructed by total active power and total steady-state current;

Step 3.3, establishing a state transfer matrix A, comprising aᵢⱼ indicates a probability of each electrical appliance's transferring from total states qₜ=sᵢ at time t transferred to total states qₜ₊₁=sⱼ at time t+1, where the calculation is:

$${a}_{ij} = \frac{{h}_{ij}}{{\sum }_{j = 1}^{N} {h}_{ij}}$$

Where hᵢⱼ is frequency of the transferring from the total states qₜ=sᵢ at time t to the total states qₜ₊₁=sⱼ at time t+1, N is total number of implicit states;

step 3.4, establishing an output matrix B, comprising bᵢₖ indicates a probability that each electrical appliance is under the total states qₜ=sᵢ at time t and observation value is yₜ=vₖ, where the calculation is:

$${b}_{ik} = \frac{{o}_{ik}}{{\sum }_{k = 1}^{M} {o}_{ik}}$$

where oᵢₖ, is frequency of each electrical appliance is under the total states qₜ=sᵢ at time t and the observation value is yₜ=vₖ, and M is the total number of the observation value;

Step 3.5, initial probability matrix, comprising: πᵢ indicates a probability that each electrical appliance is under sᵢ at an initial time, where the calculation is:

$${π}_{i} = \frac{{d}_{i}}{d}$$

where d is the total number of training data set, and dᵢ indicates frequency of the implicit stat sᵢ existed in the training data set.

Method of the step 5's performing the state recognition based on the Viterbi algorithm and obtaining the predicted state sequence comprises:

Step 5.1, initialization:

δ[0, i]=π[i]·B[i, y₀]

Step 5.2, recursive calculation:

δ[t, i]=maxⱼ(B[i, yₜ]·δ[t−1, j]·A[j, i])

ψ[t, i]=argmaxⱼ(δ[t−1, j]·A[j, i])

Step 5.3, termination state calculation:

p*_{T}=maxᵢ(δ[T, i])

q*_{T}=argmaxᵢ(δ[T, i])

Step 5.4, optimal sequence backtracking:

q*_{T}=ψₜ₊₁(q*ₜ₊₁), t=T−1, T−2, . . . , 0

where, obtained sequence is the predicted optimal implicit state sequence Q*=(q*₁, q*₂, . . . , q*_{T}).

Method of the step 6's decomposing a load power based on maximum likelihood estimation principle according to the predicted state sequence and statistical values of each cluster comprises:

Step 6.1, according to the average value and variance of the cluster of each electrical appliance sample, establishing a normal distribution probability density function of each electrical appliance in each state;

Step 6.2, establishing an objective function based on maximum likelihood estimation, so as to find the maximum of joint probability.

The objective function is:

$$\{ \begin{matrix}{f}_{[ i , j ]} ( x ) = \frac{1}{\sqrt{2 π} {σ}_{[ i , j ]}} exp ( - \frac{{( x - {μ}_{[ i , j ]} )}^{2}}{2 {σ}_{[ i , j ]}^{2}} ) \\ {max}_{{p}^{( 1 )} , … , {p}^{N}} {\prod }_{i = 1}^{N} {f}_{[ i , j ]} ( {P}^{( i )} ) \\ s . t . {\sum }_{i = 1}^{N} {P}^{i} = {P}^{L}\end{matrix}$$

where, σ_{[i,j]} and μ_{[i,j]} respectively indicates the standard deviation and the average value of j^{th} cluster of the i^{th} electrical appliance, N is the number of electrical appliances, P⁽ⁱ⁾ indicates decomposed active power of each electrical appliance, and P^{L} indicates the active power of the total loading, f_{[i,j]}(P⁽ⁱ⁾) indicates probability of i^{th} electric appliance which is in j^{th} operating state to consume power P⁽ⁱ⁾.

The beneficial effect of the invention:

The invention is based on the non-invasive load decomposition of power fingerprint and hidden Markov model with multi-parameters. The method identifies and decomposes the load working state and power by using hidden Markov model. To solve the problem that the classical HMM can only use a single electrical feature of load, a hidden Markov model with multiple parameters based on power fingerprint is provided. The improved model can make full use of electrical features and realize the state identification of electrical appliances by considering the unknown observed states of electrical appliances. Then, based on the maximum likelihood estimation principle, the power decomposition of load is realized by clustering statistical characteristics of load states. This method makes full use of the load characteristics provided by power fingerprint, and combined with the hidden Markov model, the recognition rate of non-invasive load decomposition can be improved considerably.

The non-invasive load decomposition method based on power fingerprint and hidden Markov model with multi-parameters provided by the presented invention has the following advantages and effects compared with the prior art:

(1) The non-invasive load decomposition method designed by the invention is based on the power fingerprint and the multi-parameter hidden Markov model. The utilization of the power fingerprint can extract the load state that can better reflect the load characteristics, so as to synchronously improve the accuracy of state identification and power decomposition.

(2) the invention design based on electric fingerprint and multiple parameters of the hidden Markov model of noninvasive load decomposition method, the power decomposition optimization model based on maximum likelihood estimation to decomposition, load power to a certain extent and ease the volatility, ensure that the decomposition of various electrical power is equal to the sum of the total load power, the power decomposition higher accuracy.

(3) The non-invasive load decomposition method based on power fingerprint and multivariate parameter hidden Markov model designed by the invention has reference value for the practical application of non-invasive load identification considering the unknown observation state and randomness of load power fluctuation.

Such that, the following technical problems are solved by the invention: the technical problems of load identification algorithm of conventional art using improved or expanded HMM model, which improves the accuracy of non-invasive load identification, such as complicated model, insufficient use of electrical characteristics and insufficient consideration of unknown information, a non-invasive load decomposition method is provided.

### BRIEF DESCRIPTION OF THE DRAWINGS

FIG. 1 depicts a schematic diagram of a non-invasive load decomposition method based on the invention.

### DETAILED DESCRIPTION

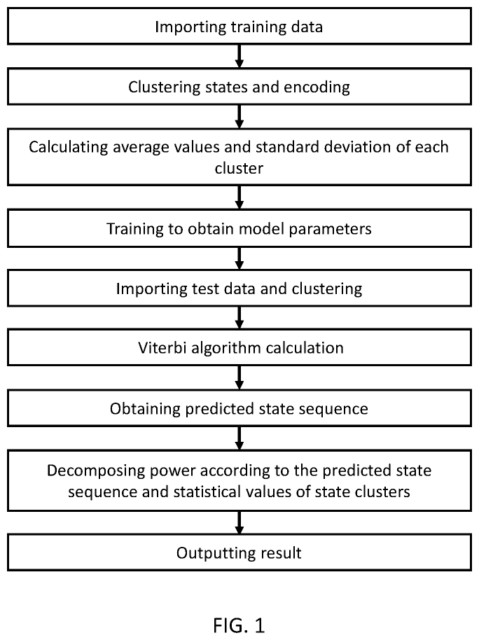

Referring to FIG. 1, non-invasive load decomposition method of the invention. This implementation takes public data set AMPds2 as the research object. Since the data set only collects low-frequency electrical data, not power fingerprint data in the strict sense, power fingerprint is defined as active power and steady-state current data in the calculation example.

The non-invasive load decomposition method based on power fingerprint and multi-parameter hidden Markov model includes following steps:

Step S110, obtaining power fingerprint of each electrical appliance. The active power and steady-state current data of hearth (WOE), clothes dryer (CDE), dishwasher (DWE), television (TVE), clothes washer (CWE) and heat pump (HPE) at 14,400 sampling points for 10 days were selected from the data set and divided evenly into 10 groups by time, denoted as test1-test10. 9 groups of data were randomly selected as training data and 1 group as test data from the divided 10 groups.

Step S120, clustering working states of electrical appliances through a clustering algorithm, calculating average values and standard deviation of each cluster, and encoding the working states of electrical appliances. After obtaining the clustering results, the average value and standard deviation of each cluster were calculated. State encoding is carried out for each electrical appliance, and the working state vector of multiple electrical appliances is encoded into a binary state value. Assuming that there are 3 electrical appliances, the number of states is 2,3,8 respectively, and the states at that time are 0,2,6 respectively. For this example, the specific encoding steps are followings:

Step 2.1, allocating bits. Determine binary bits required for encoding according to the number of states of electrical appliances. The number of states of the above three appliances is 2,3,8 respectively, so the binary digits assigned to each appliance are 1,2,3 respectively.

Step 2.2, determining values. Calculating binary state values according to decimal state values of the electrical appliances at current moment. The decimal state values of the current three appliances are 0,2,6 respectively, and the binary state values are 0,10,110 respectively.

Step 2.3, splicing representation. Splicing, according to the order of electrical appliances, the binary state values from high to low to get a final result. The state value of the state vector at the current moment after splicing is 010110.

Step S130, establishing a hidden Markov model with multiple parameters and calculating model parameters. In this embodiment, the physical meanings of the two time sequences of the multi-parameter hidden Markov model is very clear: the implicit state sequence corresponds to the operating state of each electrical appliance, and the observation sequence corresponds to the power fingerprint data of the electrical appliance. Further, the following model can be established and its parameters is calculated:

(1) Implicit state set S: in the embodiment, using S to represent a set of combined operating states of each electrical appliance, and that S is a set of total states. The set a complete sorting of the operating states of each electrical appliance. The number of elements in the set is determined by the number of clusters of the states of each electrical appliance, assuming that the number is N now, and the values are calculated by the state encoding method introduced via step S120.

(2) Observation state set V: using V to represent total power fingerprint set of total user power consumption, elements of set V, represented as vᵢ=[Pᵢ^{L}, Iᵢ^{L}], include vectors constructed by total active power and total steady-state current. Now, assuming that the number of the elements of set V is M.

(3) State transfer matrix A: comprising aᵢⱼ indicates a probability of each electrical appliance's transferring from total states qₜ=sᵢ at time t transferred to total states qₜ₊1=sⱼ at time t+1, and the calculation is:

$${a}_{ij} = \frac{{h}_{ij}}{{\sum }_{j = 1}^{N} {h}_{ij}}$$

Where hᵢⱼ is frequency of the transferring from the total states qₜ=sᵢ at time t to the total states qₜ₊₁=sⱼ at time t+1, N is total number of implicit states.

(4) Output matrix B: comprising bᵢₖ indicates a probability that each electrical appliance is under the total states qₜ=sᵢ at time t and observation value is yₜ=vₖ, and the calculation is:

$${b}_{ik} = \frac{{o}_{ik}}{{\sum }_{k = 1}^{M} {o}_{ik}}$$

Where oᵢₖ , is frequency of each electrical appliance is under the total states qₜ=sᵢ at time t and the observation value is yₜ=vₖ, and M is the total number of the observation value.

(5) Initial probability matrix: comprising: πᵢ indicates a probability that each electrical appliance is under sᵢ at an initial time, where the calculation is:

$${π}_{i} = \frac{{d}_{i}}{d}$$

Where d is the total number of training data set, and dᵢ indicates frequency of the implicit stat sᵢ existed in the training data set.

Step S140, import test data and perform clustering. In this embodiment, the test set data is derived and the input power fingerprint data is clustered to the known power fingerprint by K-means algorithm.

Step S150, performing the state recognition based on the Viterbi algorithm. For a given observation sequence Y={y₀ y₁, . . . , y_{T}} and implicit state sequence Q={q₀ q₁, . . . , q_{T}} , the specific steps of the calculation of the Viterbi algorithm are followings:

(1) Initialization:

δ[0,i]=π[i]·B[i,y₀]

Where δ[0, i] is the probability of total state q₀=i at time 0, π[i] is the initial probability of state i, and B[i, y₀] is the probability that each appliance is under total state qₜ=i while the observation value is yₜ=y₀.

(2) Recursive calculation:

δ[t,i]=maxⱼ(B[i,yₜ]·δ[t−1,j]·A[j,i])

ψ[t,i]=argmaxⱼ(δ[t−1,j]·A[j,i])

Where δ[t,i] is the probability of the total state qₜ=i at time t, B [i, y₀] is the probability of each appliance under the total state qₜ=i while the observation value yₜ=y₀, A[j, i] is the probability of the total state transferring from j to i, ψ[t, i] represents the state with the maximum probability of transferring to the total state i at time t starting from time t−1.

(3) Termination state calculation:

p*_{T}=maxᵢ(δ[T,i])

q*_{T}=argmaxᵢ(δ[T,i])

Where p*_{T} represents the probability value corresponding to the predicted total state at time T (final time), δ[T, i] is the probability of the total state qₜ=I at time T, q*_{T} represents the state corresponding to this probability (p*_{T}).

(4) Optimal sequence backtracking:

q*_{T}=ψₜ₊₁(q*ₜ₊₁), t=T−1,T−2, . . . ,0

Where q*_{T} is the predicted total state at time T. The obtained sequence is the predicted optimal implicit state sequence Q*=(q*₁, q*₂, . . . , q*_{T}).

Step S160, Viterbi algorithm computes and obtains the prediction sequence.

Step S170, according to the predicted state sequence and statistical values of each cluster, decomposing a load power based on maximum likelihood estimation principle. The power of an electric appliance in a stable operating state fluctuates, and the fluctuation can be considered as a random observation under a probability distribution. In this embodiment, normal distribution is used to describe the randomness of power fluctuation during the stable operation of electrical appliances and to calculate the power decomposition of electrical appliances. The power decomposition calculation steps of this embodiment are: (1) according to the average value and variance of the cluster of each electrical appliance sample, establishing a normal distribution probability density function of each electrical appliance in each state; (2) establishing an objective function based on maximum likelihood estimation, so as to find the maximum of joint probability. Notice the constraint that the sum of power decomposition values of all electrical appliances at the same time should be equal to the total power. The power decomposition objective function is constructed as follows:

$$\{ \begin{matrix}{f}_{[ i , j ]} ( x ) = \frac{1}{\sqrt{2 π} {σ}_{[ i , j ]}} exp ( - \frac{{( x - {μ}_{[ i , j ]} )}^{2}}{2 {σ}_{[ i , j ]}^{2}} ) \\ {max}_{{p}^{( 1 )} , … , {p}^{N}} {\prod }_{i = 1}^{N} {f}_{[ i , j ]} ( {P}^{( i )} ) \\ s . t . {\sum }_{i = 1}^{N} {P}^{i} = {P}^{L}\end{matrix}$$

where, σ_{[i,j}] and μ_{[i,j}] respectively indicates the standard deviation and the average value of j^{th} cluster of the i^{th} electrical appliance, N is the number of electrical appliances, P⁽ⁱ⁾ indicates decomposed active power of each electrical appliance, and P^{L} indicates the active power of the total loading, f_{[i,j}](P⁽ⁱ⁾) indicates probability of i^{th} electrical appliance which is in j^{th} operating state to consume power P⁽ⁱ⁾ . The above problem is a common convex quadratic programming problem after taking In on both sides of the objective function.

Step S180, outputting state sequence and power decomposition result.

The above (in combination with the attached drawings) gives a detailed description of the specific embodiments of the invention, but the invention is not limited to the above embodiments, and various modifications can be made within the scope of knowledge possessed by the ordinary person skilled in the art without deviating from the purpose of the invention.

What is claimed is:

1. A non-invasive load decomposition method, comprising:
step 1, obtaining power fingerprint of each electrical appliance to generate training data and test data;
step 2, clustering working states of electrical appliances through a clustering algorithm, calculating average values and standard deviation of each cluster, and encoding the working states of electrical appliances;
step 3, establishing a hidden Markov model with multiple parameters and calculating model parameters;
step 4, importing the test data and performing clustering;
step 5, performing state recognition based on Viterbi algorithm and obtaining a predicted state sequence;
step 6, according to the predicted state sequence and statistical values of each cluster, decomposing a load power based on maximum likelihood estimation principle; and
step 7, outputting state sequence and power decomposition result.

2. The non-invasive load decomposition method of claim 1, wherein method of the step 1's obtaining the power fingerprint of each electrical appliance to generate the training data and the test data comprises:
obtaining the power fingerprint of each electrical appliance;
selecting active power and steady-state current data of each sampling point of each electrical appliance from the data set;
dividing the selected active powers and steady-state current data into groups according to time as the training data and the test data, wherein
the power fingerprint of each electrical appliance includes the active power and the history data of 1^{st} to 11^{th} harmonics of steady-state operating current of each electrical appliance.

3. The non-invasive load decomposition method of claim 1, wherein method of the step 2's clustering the working states of the electrical appliances through the clustering algorithm, calculating the average values and the standard deviation of each cluster, and encoding the working states of the electrical appliances comprises:
clustering the working states of electrical appliances by using k-means clustering algorithm, and calculating the average values and standard of each cluster after the clustering results were obtained; and
performing state coding to each electrical appliance, so as to encode working state vector of each electrical appliance into a binary state.

4. The non-invasive load decomposition method of claim 3, method of performing the state coding to each electrical appliance, so as to encode the working state vector of each electrical appliance into the binary state comprises:
step 2.1, allocating bits, comprising: determine binary bits required for encoding according to the number of states of electrical appliances;
step 2.2, determining values, comprising: calculating binary state values according to decimal state values of the electrical appliances at current moment; and
step 2.3, splicing representation, comprising: splicing, according to the order of electrical appliances, the binary state values from high to low to get a final result.

5. The non-invasive load decomposition method of claim 1, wherein method of the step 3's establishing a hidden Markov model with multiple parameters and calculating model parameters comprises:
step 3.1, using S to represent a set of combined operating states of each electrical appliance, and that S is a set of total states, wherein the set a complete sorting of the operating states of each electrical appliance, and the number of elements in the set is determined by the number of clusters of the states of each electrical appliance;
step 3.2, using V to represent total power fingerprint set of total user power consumption, elements of set V , represented as vᵢ=[Pᵢ^{L}, Iᵢ^{L}], include vectors constructed by total active power and total steady-state current;
step 3.3, establishing a state transfer matrix A, comprising aᵢⱼ indicates a probability of each electrical appliance's transferring from total states qₜ=sᵢ at time t transferred to total states qᵢ₊₁=sⱼ at time t+1, where the calculation is:
$${a}_{ij} = \frac{{h}_{ij}}{{\sum }_{j = 1}^{N} {h}_{ij}}$$
Where hᵢⱼ is frequency of the transferring from the total states qₜ=sᵢ at time t to the total states qₜ₊₁=sⱼ at time t+1, N is total number of implicit states;
step 3.4, establishing an output matrix B, comprising bᵢₖ, indicates a probability that each electrical appliance is under the total states qₜ=sᵢ at time t and observation value is yₜ=vₖ, where the calculation is:
$${b}_{ik} = \frac{{o}_{ik}}{{\sum }_{k = 1}^{M} {o}_{ik}}$$
where oᵢₖ is frequency of each electrical appliance is under the total states qₜ=sᵢ at time t and the observation value is yₜ=vₖ, and M is the total number of the observation value; and
step 3.5, initial probability matrix, comprising: πᵢ indicates a probability that each electrical appliance is under sᵢ at an initial time, where the calculation is:
$${π}_{i} = \frac{{d}_{i}}{d}$$
where d is the total number of training data set, and dᵢ indicates frequency of the implicit stat sᵢ existed in the training data set.

6. The non-invasive load decomposition method of claim 1, wherein method of the step 5's performing the state recognition based on the Viterbi algorithm and obtaining the predicted state sequence comprises:
step 5.1, initialization:
δ[0, i]=π[i]·B[i, y₀]
step 5.2, recursive calculation:
δ[t, i]=maxⱼ(B[i, yₜ]·δ[t−1, j]·A[j, i])
ψ[t, i]=argmaxⱼ(δ[t−1, j]·A[j, i])
step 5.3, termination state calculation:
p*_{T}=maxᵢ(δ[T, i])
q*_{T}=argmaxᵢ(δ[T, i])
step 5.4, optimal sequence backtracking:
q*_{T}=ψₜ₊1(q*ₜ₊₁), t=T−1, T−2, . . . , 0
where, obtained sequence is the predicted optimal implicit state sequence Q*=(q*₁, q*₂, . . . , q*_{T}).

7. The non-invasive load decomposition method of claim 1, wherein method of the step 6's decomposing a load power based on maximum likelihood estimation principle according to the predicted state sequence and statistical values of each cluster comprises:
step 6.1, according to the average value and variance of the cluster of each electrical appliance sample, establishing a normal distribution probability density function of each electrical appliance in each state; and
step 6.2, establishing an objective function based on maximum likelihood estimation, so as to find the maximum of joint probability.

8. The non-invasive load decomposition method of claim 7, wherein the objective function is:
$$\{ \begin{matrix}{f}_{[ i , j ]} ( x ) = \frac{1}{\sqrt{2 π} {σ}_{[ i , j ]}} exp ( - \frac{{( x - {μ}_{[ i , j ]} )}^{2}}{2 {σ}_{[ i , j ]}^{2}} ) \\ {max}_{{p}^{( 1 )} , … , {p}^{N}} {\prod }_{i = 1}^{N} {f}_{[ i , j ]} ( {P}^{( i )} ) \\ s . t . {\sum }_{i = 1}^{N} {P}^{i} = {P}^{L}\end{matrix}$$
where, σ_{[i, j]} and μ_{[i, j}] respectively indicates the standard deviation and the average value of j^{th} cluster of the i^{th} electrical appliance, N is the number of electrical appliances, P⁽ⁱ⁾ indicates decomposed active power of each electrical appliance, and P^{L} indicates the active power of the total loading, f_{[i,j]}(P⁽ⁱ⁾) indicates probability of i^{th} electric appliance which is in j^{th} operating state to consume power P⁽ⁱ⁾.
